(19) United States
(12) Patent Application Publication
(10) Pub. No.: US 2025/0250042 A1
(43) Pub. Date: Aug. 7, 2025

(54) EGG FILLING APPARATUS

(71) Applicant: NABEL CO., LTD., Kyoto-shi, Kyoto (JP)

(72) Inventor: Takahiko NAMBU, Kyoto-shi (JP)

(21) Appl. No.: 18/856,435

(22) PCT Filed: Dec. 15, 2023
(86) PCT No.: PCT/JP2023/044959

§ 371 Date: Oct. 11, 2024

(30) Foreign Application Priority Data
Dec. 16, 2022 (JP) 2022-200913

(51) Int. Cl. B65B 23/08; B65B 5/08; B65B 35/38

(52) U.S. Cl. CPC B65B 23/08; B65B 5/08; B65B 35/38

(57) ABSTRACT

The present invention is an egg filling apparatus for filling an egg tray with eggs, which improves a processing speed while simplifying a configuration thereof, and includes: an individual egg cup collection unit in which egg filled cups on which eggs are placed one by one are collected; a filling location information acquisition unit that acquires information on a location where the egg is to be placed in the egg tray; an egg transfer mechanism that transfers the egg from the egg filled cup in the individual egg cup collection unit to the egg tray based on filling location information acquired by the filling location information acquisition unit; and an individual egg cup removing mechanism that removes an empty cup from the individual egg cup collection unit.

### TECHNICAL FIELD

The present invention relates to an egg filling apparatus for filling an egg tray with eggs.

### BACKGROUND ART

Examples of eggs typified by chicken eggs include eggs for producing chicks, eggs for producing vaccines, and the like, in addition to eggs for food. Such eggs are placed on an egg tray, such as a setter tray, and an egg hatching process in an egg incubator is performed.

Conventionally, before or in the middle of an egg hatching process, a plurality of eggs placed on an egg tray are inspected by an egg inspection device, and a defective egg such as a non-viable egg is removed. Then, the location where the defective egg is removed in the egg tray is newly filled with a viable egg.

Here, as a method of newly filling an egg tray with a viable egg, a stabilization facility (facility for filling an egg tray with eggs) described in Patent Literature 1 is considered in addition to manual work.

The stabilization equipment disclosed in Patent Literature 1 includes a reservoir having a plurality of cells on which eggs are placed, and a transfer plate that transfers the eggs between the reservoir and an egg tray. In this reservoir, the plurality of cells is movably provided by a guide rail. Then, in the reservoir, the cells are moved along the guide rail by a driving means, and the cells are arranged so as to correspond to the locations where the eggs are to be replenished in the egg tray. The transfer plate then transfers the eggs between the reservoir and the egg tray.

However, the above-described stabilizer requires the cells in the reservoir to be moved to correspond to the locations where the eggs are to be replenished in the egg tray, which is complicated in configuration and increases device costs. In addition, it takes time to move the cells in the reservoir, and it is difficult to improve the processing speed.

### CITATION LIST

### Patent Literature

Patent Literature 1: JP 6629752 B

### SUMMARY OF INVENTION

### Technical Problem

Therefore, an object of the present invention is to provide an egg filling apparatus for filling an egg tray with eggs, in which a processing speed of filling with the eggs is improved while simplifying a configuration thereof.

### Solution to Problem

That is, an egg filling apparatus according to the present invention is an egg filling apparatus for filling an egg tray with eggs, the apparatus comprising: an individual egg cup collection unit in which a plurality of individual egg cups on which eggs are placed one by one are collected; a filling location information acquisition unit that acquires information on a location where an egg is to be placed in the egg tray; an egg transfer mechanism that transfers an egg from an individual egg cup in the individual egg cup collection unit to the egg tray based on filling location information acquired by the filling location information acquisition unit; and an individual egg cup removing mechanism that removes an empty individual egg cup from the individual egg cup collection unit.

In this egg filling apparatus, the plurality of individual egg cups on which eggs are placed one by one are assembled in the individual egg cup collection unit, and the eggs are transferred from the individual egg cups in the individual egg cup collection unit to the egg tray by the egg transfer mechanism based on the filling location information, so that it is possible to automatically fill the egg tray with the eggs using the plurality of individual egg cups. Further, since the empty individual egg cups are removed from the individual egg cup collection unit, the individual egg cups on which the eggs are placed may be replenished by the number of the removed individual egg cups. With these configurations, in the egg filling apparatus for filling the egg tray with the eggs, it is possible to improve the processing speed of filling with the eggs while simplifying the configuration.

It is desirable that the individual egg cup removing mechanism removes an empty individual egg cup from the individual egg cup collection unit during an egg transfer operation by the egg transfer mechanism.

With this configuration, by performing the individual egg cup removing operation during the transfer operation, the processing speed can be improved as compared with a case where these operations are separately performed.

It is desirable that the egg filling apparatus according to the present invention further includes an individual egg cup replenishing mechanism that replenishes the individual egg cup collection unit with an individual egg cup on which an egg is placed.

With this configuration, the operation of replenishing the individual egg cup on which the egg is placed to the individual egg cup collection unit can be automated. In addition, by adopting a configuration in which the individual egg cups on which the eggs are placed are replenished one by one to the individual egg cup collection unit, the replenishment of the eggs can be realized by a simple configuration.

### Advantageous Effects of Invention

According to the present invention configured as described above, in the egg filling apparatus for filling the egg tray with the eggs, it is possible to improve the processing speed of filling with the eggs while simplifying the configuration.

### BRIEF DESCRIPTION OF DRAWINGS

FIG. 1 is a plan view schematically illustrating a configuration of an egg filling apparatus before a transfer operation according to an embodiment of the present invention.

FIG. 2 is a plan view schematically illustrating an individual egg cup collection unit and an egg tray at a filling position after the transfer operation in the same embodiment.

FIG. 3 is a front view schematically illustrating a configuration of an egg transfer mechanism and an individual egg cup removing mechanism during the transfer operation in the same embodiment.

FIG. 4 is a schematic view illustrating operations of the egg transfer mechanism and the individual egg cup removing mechanism of the same embodiment.

FIG. 5 is a front view schematically illustrating the operations of the egg transfer mechanism and the individual egg cup removing mechanism of the same embodiment.

### DESCRIPTION OF EMBODIMENTS

Hereinafter, an embodiment of an egg filling apparatus according to the present invention will be described with reference to the drawings. Note that any of the following drawings is schematically omitted or exaggerated as appropriate for easy understanding. The same components are denoted by the same reference numerals, and the description thereof will be omitted as appropriate.

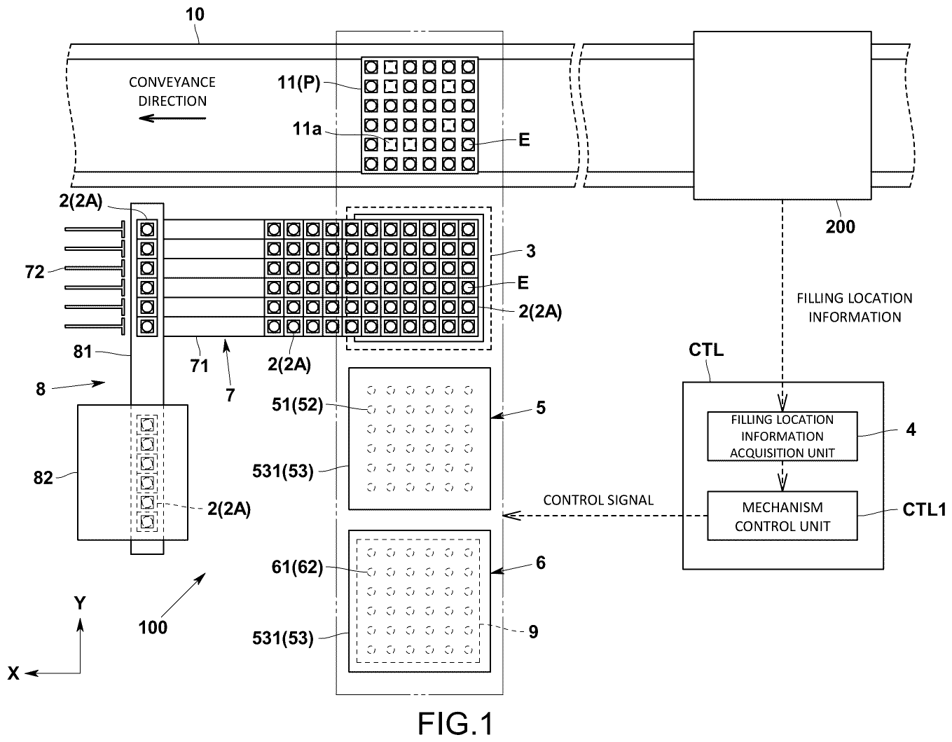

As illustrated in FIG. 1, an egg filling apparatus 100 of the present embodiment fills eggs E in an egg tray 11 such as a setter tray. Specifically, the egg filling apparatus 100 fills normal eggs in the egg tray 11 from which a defective egg such as a non-viable egg has been removed by inspection by an egg inspection device 200.

The egg filling apparatus 100 is provided at a position where the eggs E can be placed with respect to the inspected egg tray 11 conveyed on a tray conveyance path 10, and specifically, is provided on the side of the tray conveyance path 10. Here, the egg tray 11 filled with the eggs E by the egg filling apparatus 100 is stopped at a predetermined filling position P set in the tray conveyance path 10. The egg inspection device 200 is provided on the upstream side of the tray conveyance path 10.

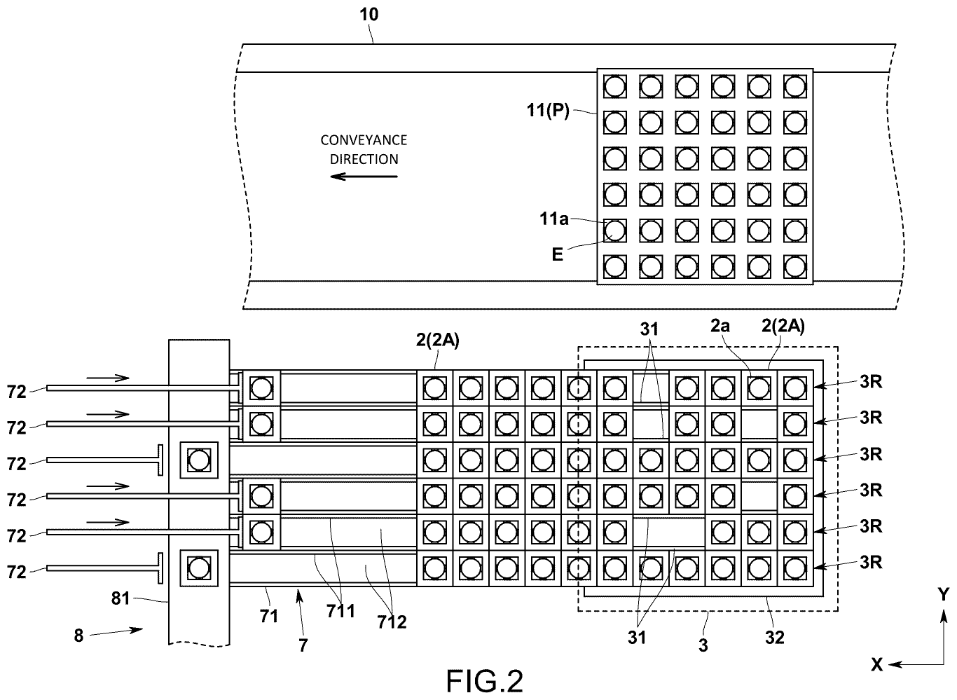

Specifically, as illustrated in FIGS. 1 and 2, the egg filling apparatus 100 includes an individual egg cup collection unit 3 in which a plurality of individual egg cups 2 (hereinafter, it is also referred to as an “egg filled cup 2A”.) on which one egg E is placed are collected, a filling location information acquisition unit 4 that acquires information on a location where the egg E is to be placed in the egg tray 11, an egg transfer mechanism 5 that transfers the egg E from the egg filled cup 2A in the individual egg cup collection unit 3 to the egg tray 11, an individual egg cup removing mechanism 6 that removes the empty individual egg cup 2 (hereinafter, it is also referred to as an “empty cup 2B”) from the individual egg cup collection unit 3, and an individual egg cup replenishing mechanism 7 that replenishes the individual egg cup collection unit 3 with the egg filled cup 2A.

In the individual egg cup collection unit 3, a plurality of egg filled cups 2A are collected. In the present embodiment, the plurality of individual egg cups 2 are collected so as to correspond to the arrangement and pitch of a plurality of egg storage seats 11a of the egg tray 11. For example, when the egg tray 11 is provided with a plurality of egg storage seats 11a in a total of 36 in 6 rows×6 columns, the individual egg cup collection unit 3 is configured to collect a plurality of the egg filled cups 2A in a total of 36 or more in 6 rows×6 columns corresponding to the arrangement and pitch of the plurality of egg storage seats 11a. In the present embodiment, a direction (Y direction) orthogonal to the conveyance direction (X direction) of the tray conveyance path 10 is set as a row, and the conveyance direction (X direction) is set as a column.

As illustrated in FIG. 2, the individual egg cup collection unit 3 includes a plurality of collecting rows 3R arranged side by side on the tray conveyance path 10 and corresponding to the plurality of rows of the egg tray 11, and is configured such that the plurality of individual egg cups 2 are collected in each collecting row 3R. Specifically, the individual egg cup collection unit 3 includes guide rails 31 for forming the plurality of collecting rows 3R. The guide rails 31 are replenished with the individual egg cups 2 by an individual egg cup replenishing mechanism 7 described later. In addition, the individual egg cup collection unit 3 has a regulating member 32 for defining a collecting region of the plurality of individual egg cups 2. The individual egg cup collection unit 3 is configured to support the individual egg cups 2 by the guide rails 31, but may be configured to include a support member that supports the individual egg cups 2 separately from the guide rails 31.

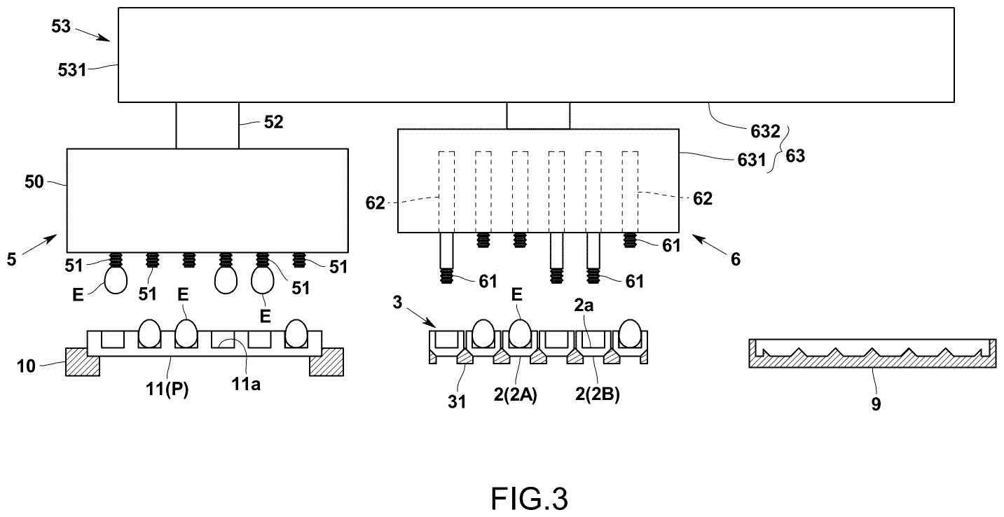

Here, as illustrated in FIGS. 2 and 3, the individual egg cup 2 is configured to store one egg E, and has, for example, a rectangular shape in plan view, and a storage portion 2a for storing one egg E is formed in a central portion thereof. In the present embodiment, the side surfaces of the plurality of individual egg cups 2 come into contact with each other at least in the collection row 3R, so that the interval between the storage portions 2a is the same as or substantially the same as the interval between the egg storage seats 11a of the egg tray 11.

As illustrated in FIG. 1, the filling location information acquisition unit 4 acquires information on a location where the egg E is to be placed in the egg tray 11. Here, the location where the egg is to be placed is, for example, the location of the egg storage seat 11a from which a defective egg such as a non-viable egg is removed in the egg tray 11.

Specifically, the filling location information acquisition unit 4 acquires the filling location information from the egg inspection device 200 that has performed the operation of removing a defective egg. The filling location information is position information of the egg storage seat 11a from which the defective egg has been removed. Here, when the filling location information acquisition unit 4 is configured to acquire the filling location information from the egg inspection device 200, it is conceivable that the filling location information acquisition unit 4 is configured by a control device CTL described later. The filling location information acquisition unit 4 may be, for example, a filling location detection device such as an optical sensor that detects the egg storage seat 11a in which the egg E is not stored in the egg tray 11, separately from the egg inspection device 200.

As illustrated in FIGS. 1 and 3, the egg transfer mechanism 5 transfers the egg E from the egg filled cup 2A in the individual egg cup collection unit 3 to the egg tray 11 based on the filling location information acquired by the filling location information acquisition unit 4. The egg transfer mechanism 5 is provided so as to be movable above the individual egg cup collection unit 3 and the egg tray 11 at the filling position P.

Based on the filling location information, the egg transfer mechanism 5 sucks and lifts the egg E from the egg filled cup 2A in the individual egg cup collection unit 3, and transfers the egg E to the egg storage seat 11a to be filled in the egg tray 11.

Specifically, as illustrated in FIG. 3, the egg transfer mechanism 5 includes a holder 50 having egg sucking units 51 that suck the egg E, a raising/lowering moving unit 52 that moves the holder 50 up and down, and a moving mechanism 53 that moves the egg sucking unit 51 and the raising/lowering moving unit 52 between the individual egg cup collection unit 3 and the egg tray 11 at the filling position P. The suction operation by the egg sucking unit 51, the raising and lowering operation by the raising/lowering moving unit 52, and the moving operation by the moving mechanism 53 are controlled by a mechanism control unit CTL1 of the control device CTL described later.

In the present embodiment, in the holder 50, a plurality of the egg sucking units 51 are provided corresponding to the plurality of individual egg cups 2, respectively. For example, in the individual egg cup collection unit 3, when a plurality of individual egg cups 2 are collected in a total of 36 in 6 rows×6 columns, a total of 36 egg sucking units 51 in 6 rows×6 columns are provided.

The egg sucking unit 51 is connected to a suction device (not illustrated), and sucks the egg E by the suction device. An elastically deformable suction pad is provided at the tip of the egg sucking unit 51.

The raising/lowering moving unit 52 can be configured using, for example, an actuator such as an air cylinder. In addition, the moving mechanism 53 can be configured using a slide moving mechanism 531 that slides the egg sucking units 51 and the holder 50. As the slide moving mechanism 531, for example, a configuration using a motor and a ball screw mechanism or a configuration using a linear actuator such as a linear motor can be considered.

As illustrated in FIG. 3, the individual egg cup removing mechanism 6 removes the empty cups 2B from the individual egg cup collection unit 3. The individual egg cup removing mechanism 6 is provided so as to be movable forward and backward above the individual egg cup collection unit 3.

In addition, the individual egg cup removing mechanism 6 removes the empty cups 2B by sucking and lifting the empty cups 2B in the individual egg cup collection unit 3 based on the filling location information. The individual egg cup removing mechanism 6 releases the sucked empty cups 2B in the cup recovery unit 9.

Specifically, the individual egg cup removing mechanism 6 includes cup sucking units 61 that suck the empty cup 2B, raising/lowering moving units 62 that move the cup sucking units 61 up and down, and a moving mechanism 63 that moves the cup sucking units 61 and the raising/lowering moving units 62 forward and backward with respect to the egg tray 11. The suction operation by the cup sucking unit 61, the raising and lowering operation by the raising/lowering moving unit 62, and the moving operation by the moving mechanism 63 are controlled by the mechanism control unit CTL1 of the control device CTL described later.

In the present embodiment, a plurality of cup sucking units 61 and a plurality of raising/lowering moving units 62 are provided corresponding to the plurality of individual egg cups 2, respectively. For example, in the individual egg cup collection unit 3, when a plurality of individual egg cups 2 are collected in a total of 36 in 6 rows×6 columns, a total of 36 cup sucking units 61 and raising/lowering moving units 62 in 6 rows×6 columns are provided.

The cup sucking unit 61 sucks the bottom surface of the storage portion 2a of the empty cup 2B. The cup sucking unit 61 is connected to a suction device (not illustrated), and sucks the empty cup 2B by the suction device. An elastically deformable suction pad is provided at the tip of the cup sucking unit 61.

The raising/lowering moving unit 62 can be configured using, for example, an actuator such as an air cylinder. In addition, the moving mechanism 63 can be configured using a holding body 631 provided with the cup sucking units 61 and the raising/lowering moving units 62, and a slide moving mechanism 632 that slidingly moves the holding body 631. As the slide moving mechanism 632, for example, a configuration using a motor and a ball screw mechanism or a configuration using a linear actuator such as a linear motor can be considered. A part of the configuration of the slide moving mechanism 632 (for example, a guide rail or the like) may be shared with the slide moving mechanism 531 of the egg transfer mechanism 5.

Here, the egg transfer mechanism 5 and the individual egg cup removing mechanism 6 are controlled to move in conjunction with each other by the mechanism control unit CTL1 of the control device CTL described later. Specifically, at least the movement of the egg transfer mechanism 5 by the moving mechanism 53 and the movement of the individual egg cup removing mechanism 6 by the moving mechanism 63 are controlled to be interlocked. In addition, the raising and lowering of the holder 50 by the raising/lowering moving unit 52 of the egg transfer mechanism 5 and the raising and lowering of the cup sucking units 61 by the raising/lowering moving units 62 of the individual egg cup removing mechanism 6 may be controlled to be interlocked.

Specifically, in a state where the holder 50 of the egg transfer mechanism 5 is positioned above the individual egg cup collection unit 3, the holder 631 of the individual egg cup removing mechanism 6 is at a position retracted from the individual egg cup collection unit 3. When the holder 50 of the egg transfer mechanism 5 moves from above the individual egg cup collection unit 3 to above the egg tray 11, the holder 631 of the individual egg cup removing mechanism 6 moves to above the individual egg cup collection unit 3 (see FIG. 3).

As illustrated in FIGS. 1 and 2, the individual egg cup replenishing mechanism 7 replenishes the individual egg cup collection unit 3 with the egg filled cups 2A. The individual egg cup replenishing mechanism 7 replenishes the individual egg cup collection unit 3 with the egg filled cups 2A as many as the number of the empty cups 2B removed by the individual egg cup removing mechanism 6.

Specifically, the individual egg cup replenishing mechanism 7 replenishes the egg filled cup 2A for each collection row 3R of the individual egg cup collection unit 3, and includes a replenishment path 71 connected to the individual egg cup collection unit 3 to replenish the egg filled cup 2A, and a push-out unit 72 that pushes out the egg filled cup 2A on a supply conveyor 81 described later to a replenishment path 71 to replenish the egg filled cup 2A.

The replenishment path 71 is provided corresponding to each collection row 3R of the individual egg cup collection unit 3, and the push-out unit 72 is also provided corresponding to each collection row 3R of the individual egg cup collection unit 3. The replenishment path 71 has, for example, a linear shape, and is formed by, for example, guide rails 711 connected to the guide rails 31 forming the collection row 3R and a belt conveyor 712. In addition, the push-out unit 72 supplies the egg filled cup 2A to the replenishment path 71 by pushing out the egg filled cup 2A from the supply conveyor 81. As a result, the egg filled cup 2A is conveyed to the individual egg cup collection unit 3 by the belt conveyor 712 of the replenishment path 71, and the gap formed by removing the empty cup 2B is filled with the egg filled cup 2A. The push-out unit 72 can be configured using, for example, an actuator such as an air cylinder.

Furthermore, in the present embodiment, the individual egg cup supply mechanism 8 that supplies the egg filled cup 2A to the replenishment path 71 is provided. The individual egg cup supply mechanism 8 includes, for example, a supply conveyor 81 provided on the upstream side of the replenishment path 71 so as to cross the replenishment path 71. The supply conveyor 81 supplies the egg filled cups 2A to the replenishment path 71 in a state of being arranged in a line. The egg filled cups 2A supplied by the supply conveyor 81 are supplied to the replenishment path 71 by the push-out unit 72.

The individual egg cup supply mechanism 8 may include a supply device 82 that supplies the egg filled cups 2A to the upstream side of the supply conveyor 81. For example, the supply device 82 uses the empty cup 2B collected by the cup collection unit 9 to place an egg on the empty cup 2B to form the egg filled cup 2A, and supplies the egg filled cup 2A to the supply conveyor 81. Note that a circulation path (not illustrated) is provided between the supply device 82 and the cup collection unit 9. By this feeding device 82, the empty cup 2B is reused and circulated in the egg filling apparatus 100. The egg filled cup 2A may be manually supplied to the supply conveyor 81.

### Operation of Egg Filling Apparatus 100

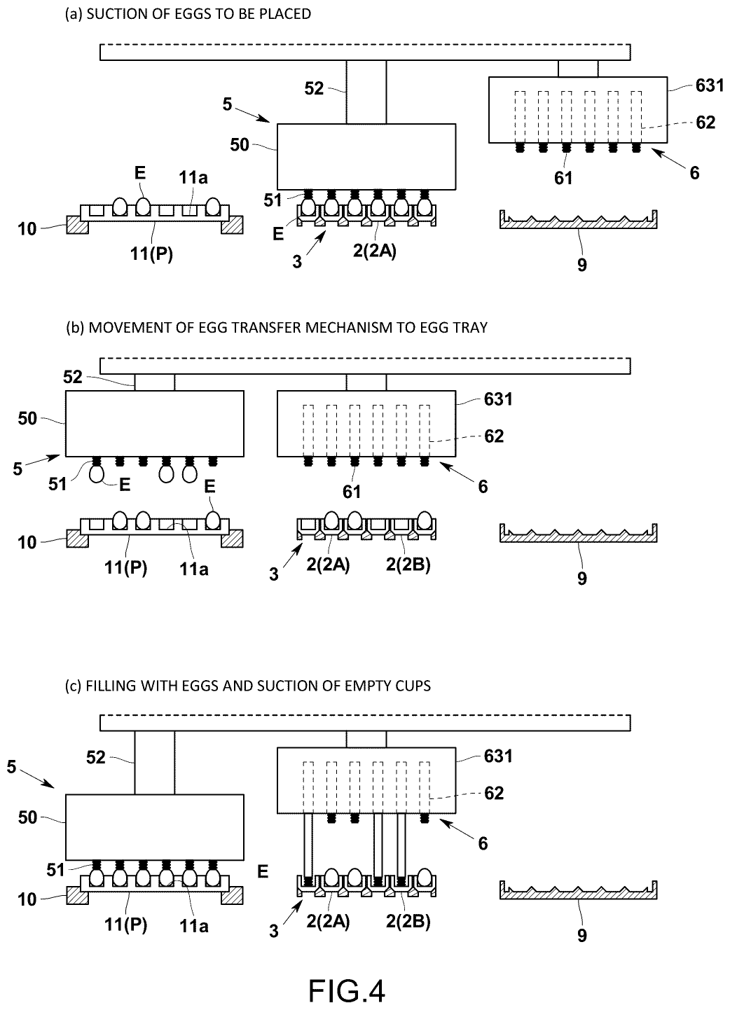

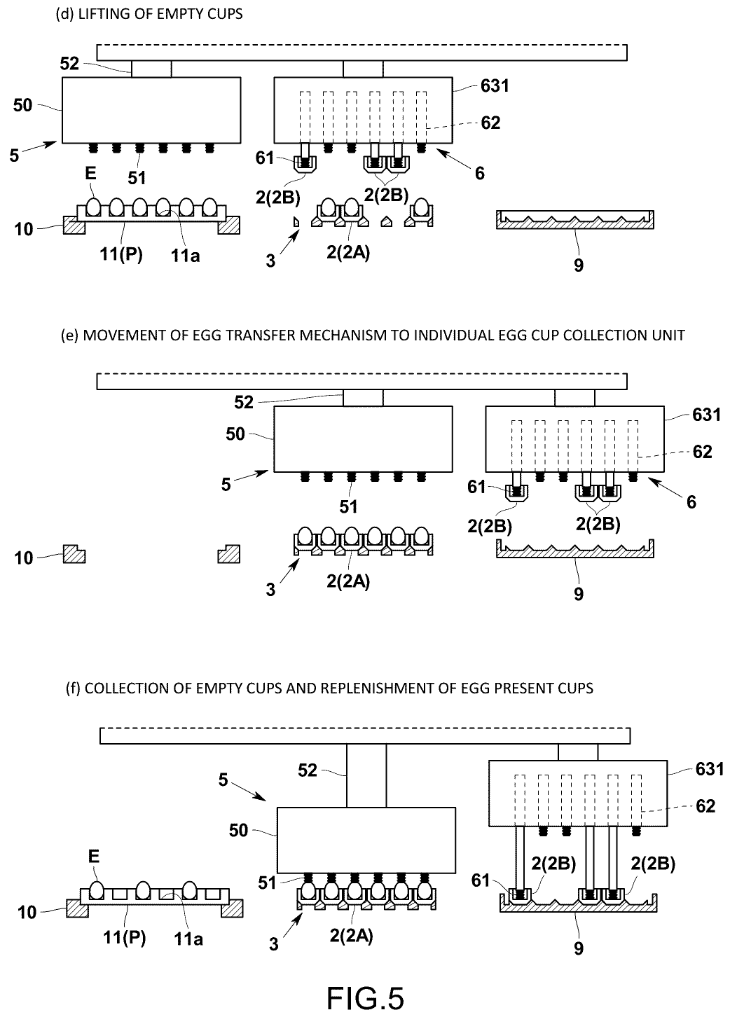

Next, the operation of the egg filling apparatus 100 of the present embodiment will be described particularly with reference to FIGS. 4 and 5.

The following operation is performed by controlling each unit by the mechanism control unit CTL1 of the control device CTL provided in the egg filling apparatus 100. The control device CTL is a computer including a CPU, a memory, an input/output interface, an AD converter, a communication device, and the like.

First, the egg tray 11 inspected by the egg inspection device 200 in the tray conveyance path 10 is stopped at the predetermined filling position P. Further, the filling location information acquisition unit 4 acquires the filling location information from the egg inspection device 200.

Then, the egg transfer mechanism 5 standing by above the individual egg cup collection unit 3 sucks and lifts the eggs E corresponding to the filling locations from the individual egg cup collection unit 3 based on the filling location information. Specifically, the raising/lowering moving unit 52 of the egg transfer mechanism 5 lowers the holder 50, and the egg sucking unit 51 sucks the eggs E based on the filling location information (see FIG. 4 at (a)). When the egg sucking unit 51 sucks the eggs E, the raising/lowering moving unit 52 raises the holding body 50.

When the standby position of the holding body 50 of the egg transfer mechanism 5 is not above the individual egg cup collection unit 3, the above operation is performed after the holding body 50 is moved above the individual egg cup collection unit 3.

Then, the egg transfer mechanism 5 moves to the egg tray 11 in a state of sucking the eggs E (see FIG. 4 at (b)), and stores the eggs E in the egg storage seats 11a at the filling locations (see FIG. 4 at (c)). Specifically, the holder 50 of the egg transfer mechanism 5 moves above the egg tray 11 (see FIG. 4 at (b)). After the movement, the raising/lowering moving unit 52 lowers the holding body 50, and the egg sucking unit 51 of the lowered holding body 50 releases the suction of the eggs E and stores the eggs E in the egg storage seats 11a at the filling locations (see FIG. 4 at (c)). When the egg sucking unit 51 releases the suction of the eggs E, the raising/lowering moving unit 52 raises the holder 50 (see FIG. 5 at (d)).

Here, the individual egg cup removing mechanism 6 moves to the individual egg cup collection unit 3 in conjunction with the movement of the egg transfer mechanism 5 to the egg tray 11 (see FIG. 4 at (b)), and sucks and lifts the empty cup 2B (see FIG. 4 at (c) and 5 at (d)). Specifically, the holder 631 of the individual egg cup removing mechanism 6 moves above the individual egg cup collection unit 3 (see FIG. 4 at (b)). After the movement, the raising/lowering moving units 62 lower the cup sucking units 61 on the basis of the filling location information, and the cup sucking units 61 that have been lowered suck the empty cup 2B (see FIG. 4 at (c)). When the cup sucking units 61 suck the empty cups 2B, the raising/lowering moving units 62 raise the cup sucking units 61 (see FIG. 5 at (d))

When the empty cups 2B are lifted from the individual egg cup collection unit 3, the individual egg cup replenishing mechanism 7 operates to replenish the individual egg cup collection unit 3 with the egg filled cups 2A (see FIG. 5 at (e)). Specifically, the egg filled cups 2A on the replenishment path 71 are conveyed by the belt conveyor 712 toward the individual egg cup collection unit 3 (see FIG. 2), whereby the portions removing the empty cups 2B are replenished with the egg filled cups 2.

Note that the individual egg cup supply mechanism 8 supplies the egg filled cups 2A to the replenishment path 71 at a timing when the number of the egg filled cups 2A remaining in the replenishment path 71 falls below a predetermined number.

Thereafter, the egg transfer mechanism 5 that releases the eggs E moves to the individual egg cup collection unit 3, and the individual egg cup removing mechanism 6 that has sucked the empty cups 2B is retracted from the individual egg cup collection unit 3 (see FIG. 5 at (e)). At a position where the individual egg cup removing mechanism 6 is retracted from the individual egg cup collection unit 3, the cup collection unit 9 for collecting the empty cups 2B is provided below the individual egg cup removing mechanism 6, and the individual egg cup removing mechanism 6 stores the empty cups 2B in the cup collection unit 9 (see FIG. 5 at (f)). As described above, the individual egg cup removing mechanism 6 performs an operation of removing the empty cups 2B from the individual egg cup collection unit 3 during the transfer operation of the eggs E by the egg transfer mechanism 5. In addition, at the same time as the operation in which the individual egg cup removing mechanism 6 stores the empty cups 2B in the cup collection unit 9, the egg transfer mechanism 5 performs an operation of lifting the eggs E from the individual egg cup collection unit 3 based on the filling location information in the next egg tray 11.

### Effects of Present Embodiment

According to the egg filling apparatus 100 of the present embodiment, the plurality of egg filled cups 2A on which the eggs E are placed one by one are assembled in the individual egg cup collection unit 3, and the eggs E are transferred from the egg filled cups 2A in the individual egg cup collection unit 3 to the egg tray 11 by the egg transfer mechanism 5 based on the filling location information, so that the eggs E can be automatically placed in the egg tray 11 using the plurality of egg filled cups 2A. In addition, since the empty cups 2B are removed from the individual egg cup collection unit 3, the egg filled cups 2A may be replenished as many as the number of the removed empty cups 2B. With these configurations, in the egg filling apparatus 100 for filling the egg tray 11 with the eggs E, the processing speed can be improved while simplifying the configuration.

In addition, in the present embodiment, the individual egg cup removing operation by the individual egg cup removing mechanism 6 is performed during the transfer operation of the eggs E by the egg transfer mechanism 5, so that the processing speed of filling with the eggs E can be improved as compared with the case of separately performing these operations.

Furthermore, in the present embodiment, since the individual egg cup replenishing mechanism 7 refills the individual egg cup collection unit 3 with the egg filled cups 2A, the operation of refilling the individual egg cup collection unit 3 with the egg filled cups 2A can be automated. In addition, the individual egg cup collection unit 3 can be replenished with the egg filled cups 2A one by one, and the replenishment of the egg filled cups 2A can be realized by a simple configuration.

### Modified Embodiment of Present Invention

The present invention is not limited to the above embodiment.

For example, in the above embodiment, the individual egg cup removing operation by the individual egg cup removing mechanism 6 is performed during the transfer operation of the eggs E by the egg transfer mechanism 5, but these operations may be performed at different timings. For example, the individual egg cup removing operation by the individual egg cup removing mechanism 6 may be performed after the end of the transfer operation of the eggs E by the egg transfer mechanism 5 and before the start of the next transfer operation.

In the above embodiment, the holding body 50 provided with the plurality of egg sucking units 51 is raised and lowered, but the plurality of egg sucking units 51 may be individually raised and lowered based on the filling position information.

In addition, the present invention is not limited to the above embodiment, and it goes without saying that various modifications can be made without departing from the gist of the present invention.

### INDUSTRIAL APPLICABILITY

According to the present invention, in the egg filling apparatus for filling the egg tray with the eggs, the processing speed can be improved while simplifying the configuration.

### LIST OF REFERENCE CHARACTERS

100 egg filling apparatus
11 egg tray
2 individual egg cup
2A egg filled cup
2B empty cup
3 individual egg cup collection unit
4 filling location information acquisition unit
5 egg transfer mechanism
6 individual egg cup removing mechanism
7 individual egg cup replenishing mechanism

1. An egg filling apparatus for filling an egg tray with eggs, the apparatus comprising:
an individual egg cup collection unit in which a plurality of individual egg cups on which eggs are placed one by one are collected;
a filling location information acquisition unit that acquires information on a location where an egg is to be placed in the egg tray;
an egg transfer mechanism that transfers an egg from an individual egg cup in the individual egg cup collection unit to the egg tray based on filling location information acquired by the filling location information acquisition unit; and
an individual egg cup removing mechanism that removes an empty individual egg cup from the individual egg cup collection unit.

2. The egg filling apparatus according to claim 1, wherein the individual egg cup removing mechanism removes an empty individual egg cup from the individual egg cup collection unit during an egg transfer operation by the egg transfer mechanism.

3. The egg filling apparatus according to claim 1, further comprising an individual egg cup replenishing mechanism that replenishes the individual egg cup collection unit with an individual egg cup on which an egg is placed.
